(19) United States
(12) Patent Application Publication
(10) Pub. No.: US 2008/0189336 A1
(43) Pub. Date: Aug. 7, 2008

(54) CREATING AND MANAGING DIGITAL MEDIA CONTENT USING CONTACTS AND RELATIONAL INFORMATION

(75) Inventor: Andrew PRIHODKO, Cambridge, MA (US)

Correspondence Address: WILMERHALE/BOSTON, 60 STATE STREET, BOSTON, MA, 02109, US

(73) Assignee: NameMedia, Inc., Waltham, MA (US)

(21) Appl. No.: 12/026,092

(22) Filed: Feb. 5, 2008

Related U.S. Application Data
(60) Provisional application No. 60/899,453, filed on Feb. 5, 2007.

(51) Int. Cl. G06F 17/00

(52) U.S. Cl. 707/104.1; 707/E17.009

(57) ABSTRACT

Tags are used to describe the contents of digital content, such as photographs. Tags can be linked across different user accounts such that clicking on a tag/keyword in a user's account will bring up all photos in the user's account, as well as the photos from other users that are associated/labeled with that same tag. When a user adds a new tag to a photo in the user's collection, that tag can be stored for future use.

### CROSS-REFERENCE TO RELATED APPLICATION

This application is a non-provisional filing related under § 119(e) to Provisional Application No. 60/899,453, filed Feb. 5, 2007, which is incorporated herein by reference.

### BACKGROUND

With the emergence of the Internet and Internet-accessible network devices, such as PDAs, cell phones, and digital cameras, mainstream consumers are accumulating growing collections of digital content, including still images, audio, and video. As people accumulate more digital content files, managing and sharing that content efficiently becomes increasingly more challenging. Existing online services for managing photos offer the ability to create tags to annotate files for easier management.

### SUMMARY

Tags, also referred to as keywords, are words used to describe the contents of digital content, such as photographs. In the system described here, tags/keywords are classified in different ways. In one embodiment, the classifications are people, places, and things/events. Creation date information can also be provided or can be grabbed from the content itself. These tags can appear as links underneath the photos they describe. Tags can be linked across accounts such that clicking on a tag/keyword in a user's account will bring up all photos in the user's account, as well as the photos from other users that are associated/labeled with that same tag. When a user adds a new tag to a photo in the user's collection, that tag can be stored for future use. The collection of stored tags is referred to as the user's “tag library.” The collective inventory of tags stored in the system is referred to as the public tag library.

The systems and methods described here can improve the manner in which consumers/users organize and share their personal digital media. The systems and methods can also be applied in other areas, such as contact management tools and other applications that rely on consistent labeling of information so that multiple parties can access and share all of the relevant information quickly and efficiently.

Processes are based on psychology and social incentives to stimulate users to annotate the media extensively with descriptive tags that can be entered in multiple languages and shared among multiple users. These processes encourage multiple users with media containing similar content classify those media with the same tags. Consequently, users can generate content that yields good search precision and efficient management of digital media.

By using psychological triggers, social incentives, and relational information based on tag associations and frequencies, potential users receive and are induced to view content relevant to them. These methods can help encourage high registration rates.

The systems and methods promote high functionality online sharing by inducing users to organize in a uniform manner.

Other features and advantages will become apparent from the following detailed description and drawings.

### DETAILED DESCRIPTION OF THE DRAWINGS

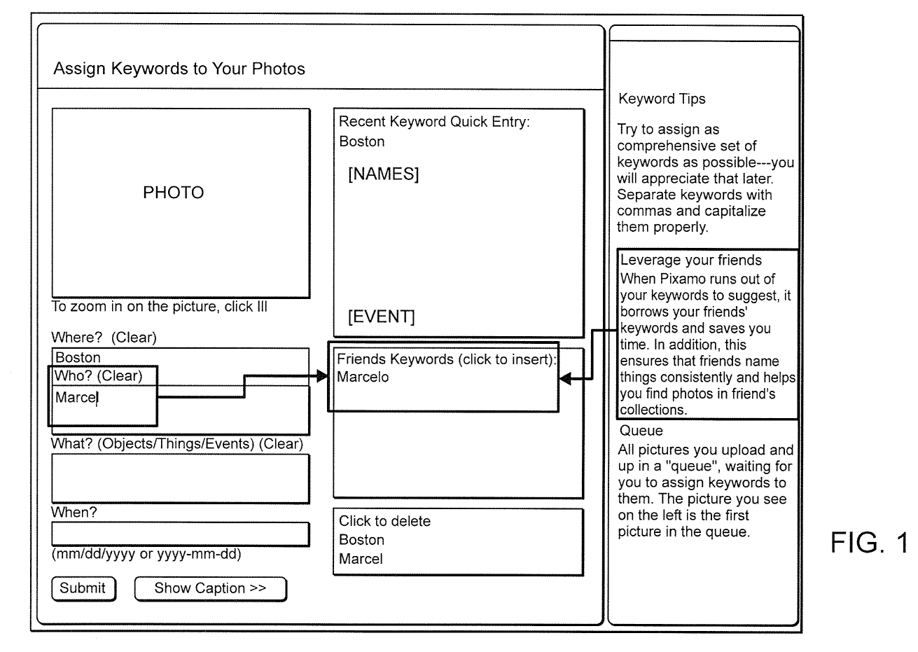

FIG. 1 is a screen shot showing assigning keywords to photos.

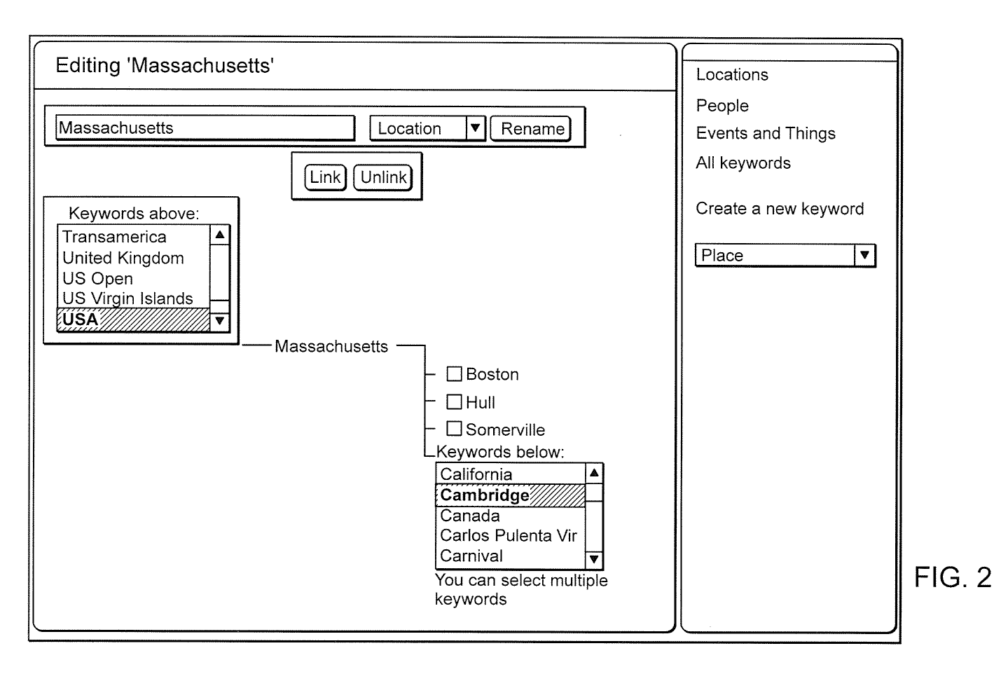

FIG. 2 is a screen shot showing the ability to create hierarchies with keywords.

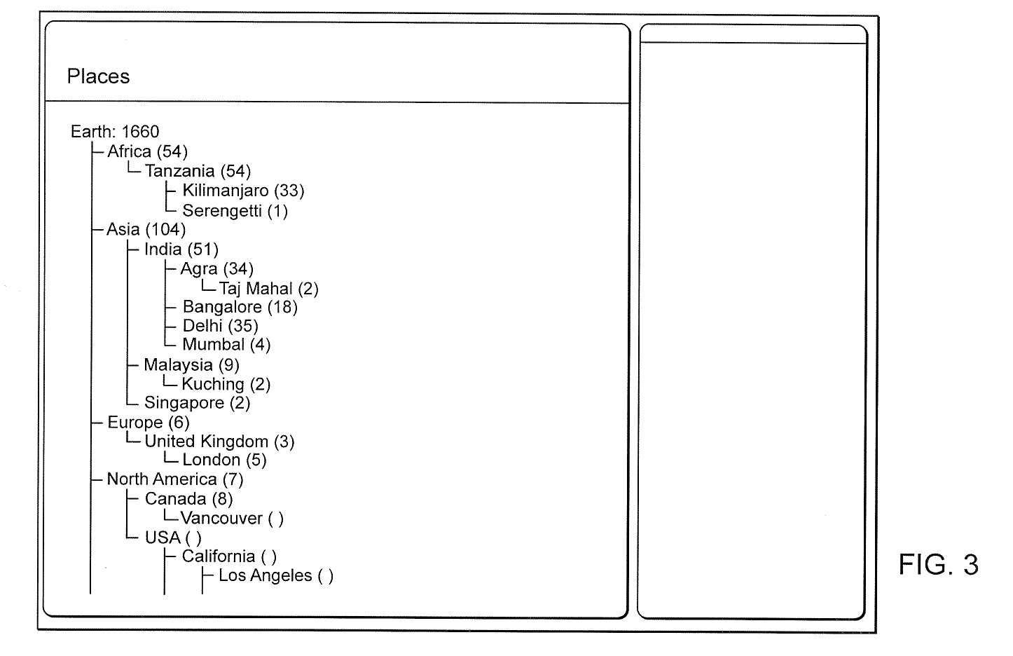

FIG. 3 is a screen shot showing sampling tag hierarchy for places.

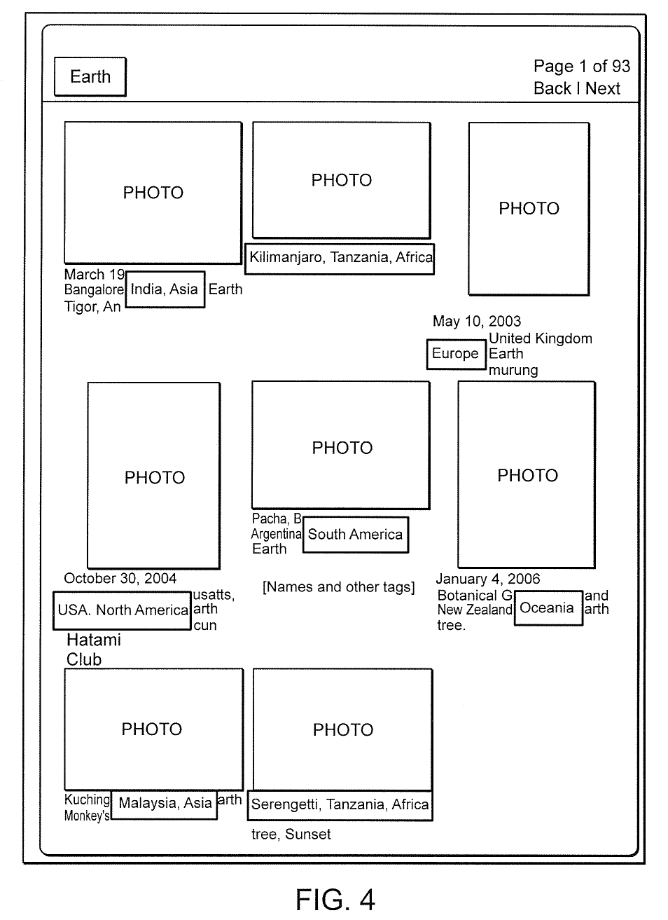

FIG. 4 is a screen shot showing distributed search maximizing browsing options.

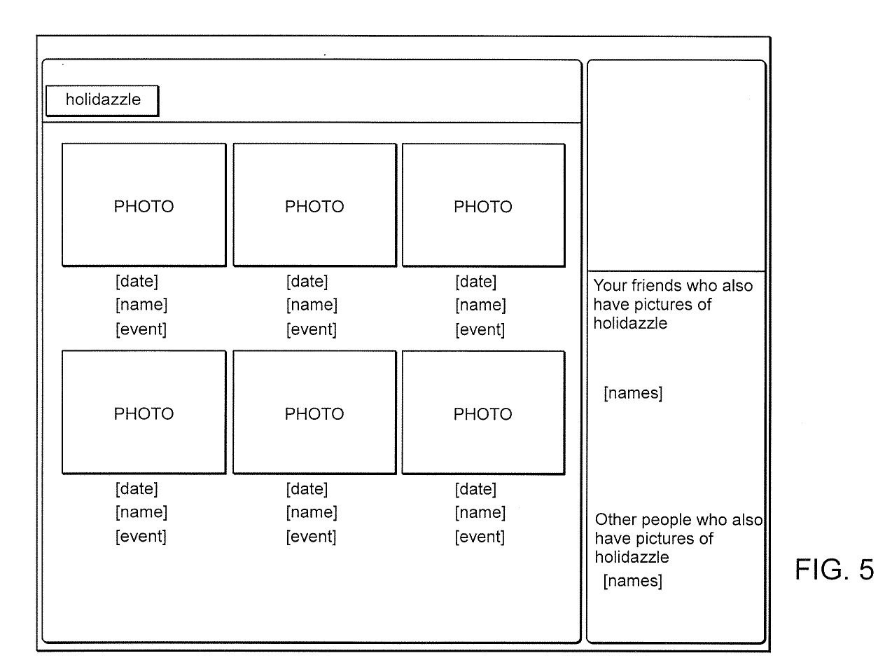

FIG. 5 is a screen shot showing continual delivery of relevant content.

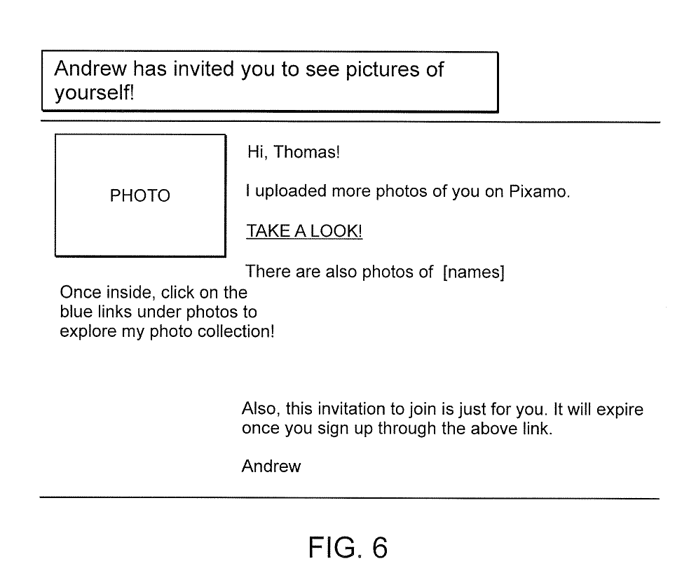

FIG. 6 is a screen shot showing a sample invitation e-mail.

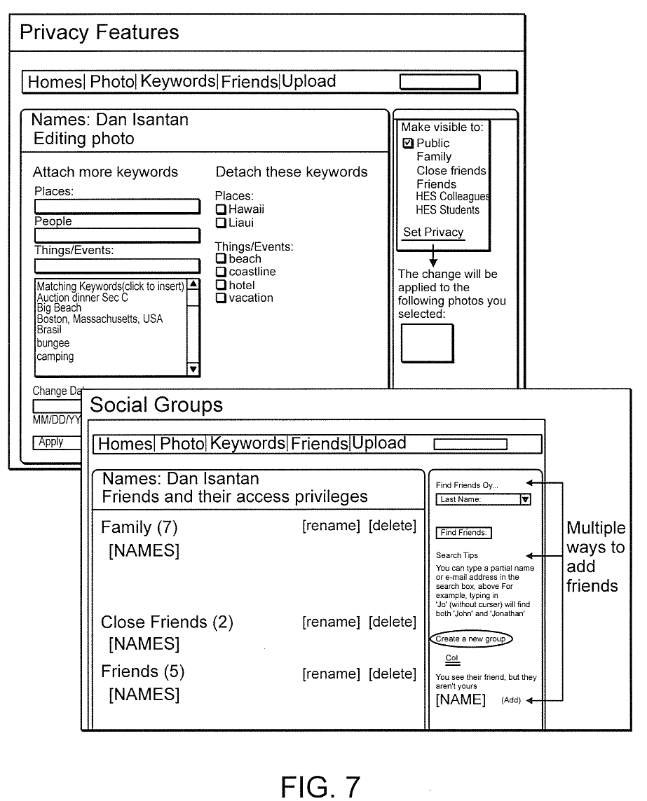

FIG. 7 is a screen shot showing privacy features and social groups.

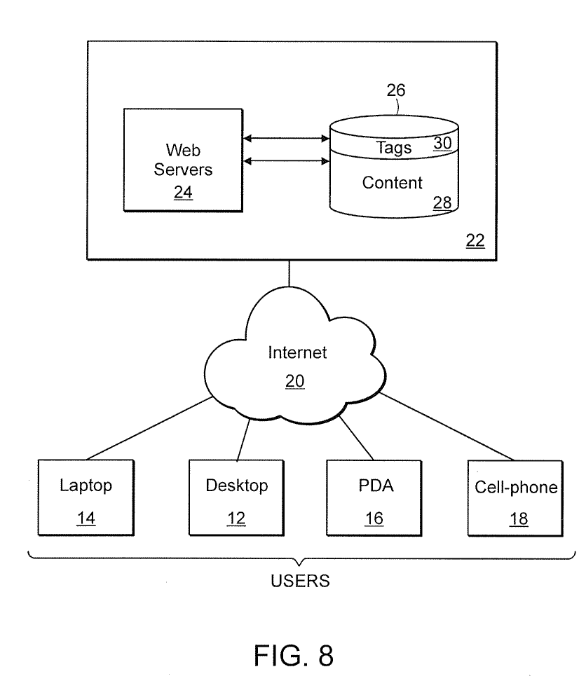

FIG. 8 is a block diagram of a system according to one embodiment.

### DETAILED DESCRIPTION

The systems and methods described here are described in conjunction with the use of photos or other still images. However, notwithstanding any references to photos or still images, these systems and methods could be used with other digital content or files, such as text files, audio files, video files, and combinations of these or any other types of content.

Referring to FIG. 8, in these systems and methods, a user 10 can use a network-accessible user device, such as a desktop computer 12, laptop computer 14, a personal digital assistant (PDA) 16, a cellular telephone 18, or any other device that is capable of communicating with a network of many users. The network could be any kind of network 20, but is assumed here to be the Internet. The system could also be used with an intranet or with any other network that is accessible by a large number of people.

A user with a network device communicates with a server system 22 that could include one or more web servers 24 or other combination of hardware and software. The server system includes memory or is coupled to memory (such as one or more databases 26) that can store uploaded digital content 28, tags 30 (and any other metadata), and other information about users. The memory can be divided into separate stores for the content and the tags and other metadata, or they can be combined. The server(s) or other computer(s) have hardware (general and/or specific purpose) and software. The software provides the ability of the server to interact with the user. In the example of the Internet, the server system provides HTML pages that can include information and methods for the user to input information, such as text boxes. The software can also include a database management system, and other systems that can be useful, such as an email server.

The software can be provided on any computer readable medium, including one or a combination of magnetic, optical, or solid state media, and operated on one or more processors.

### Content Creation

When uploading digital content from a network device to a server, a user is provided with a page to allow the user to enter descriptive tags to classify the user's files. In the example of photos, the user enters who and what appear in the image, as well as when and where the image was taken. FIG. 1 shows a screen shot with a photo (e.g., of two people at an event) and boxes for “where”, “who” and “when.” The system encourages users to assign a comprehensive set of keywords. The tags can be entered in a basically free form manner. The tags need not be entered in quotation marks, and are separated by commas. The system encourages the user to break apart phrases into individual words and classify them (e.g., into people, places, and events). For other content, such as audio, other categories of tags could be used, such as a classification of tags that could indicate musical styles. The system can automatically grab certain data, such as a time/date stamp in the case of photos.

Algorithms guide, correct, accelerate, and enhance the user's tagging experience. For example, popup messages corresponding to each classification category guide the user through tag creation and entry, providing edits and other suggestions. In addition to using established sources, such as dictionaries, to ensure appropriate spelling and language, a user's tags are screened against a database of tags created by other users. Beyond providing the appropriate spelling of a person's name or an event that may not be in any dictionary, this tool identifies inconsistencies between tags used by two different people to describe the same thing. Further, it allows for suggesting that related tags be linked based on how they have been associated in other users' collections. For example a new user organizing media with the keyword “Cambridge”, could be offered the option of linking the keyword “Cambridge” to “Massachusetts” and “USA,” or only to “UK”.

### Auto Complete and Shared Tagging

The system provides an auto complete and shared tagging functionality. The system can import tags from other users' libraries without having to retype the tags, thereby reducing the annotation process and helping to ensures consistent tagging of identical media across multiple users' accounts. Therefore, finding files in other users' accounts can be made as easy as finding the files in a user's own account.

A user's newly created tags are automatically stored in a library and suggested during subsequent file uploads after the user has typed the first letters of the desired keyword. If the user has never used a particular tag, the system searches the user's friends' libraries and suggests similar tags from within that contact network. If the tag cannot be found in any friend's library, the libraries of those friends' friends are searched followed by the libraries of all users, and finally, a dictionary search. FIG. 1 illustrates an uploading user who has entered the first few letters of a person's name in the “who” box on the left side of the screen. Because the user's library does not contain a similar keyword, the libraries of his immediate friends are searched and the name “Marcelo <last name>” is retrieved. The user can click on this suggested tag to associate with his image, thereby reducing typing and reducing the risk of error in entering the name correctly.

Searching for data within a user's immediate friend circle also increases the probability that relevant tags are entered, as close friends are more likely to have common interests, acquaintances, and experiences. A user looking to tag a photo or video of “John Smith” from Idaho rather than John Smith from New York is more likely to find the correct John Smith in his immediate friend's library.

As also shown in FIG. 1, there is a box for recent keyword quick entry that can list tags that have been categorized. As shown here, there is a recent “place” tag (Boston), “name” tags (shown here as “[NAMES]”, but a number of actual names would be used here), and an “event.” This box encourages users to use consistent names for people, places, and events and helps avoid misspellings from re-typing.

The system has a keyword validator tool that is designed to promote extensive tagging and ensure tagging consistency among users belonging to a contact network. The validator tool can involve education during a user's uploads, such as the first three uploads in particular. During the annotation process, popup messages provide suggestions for keywords and keyword types. After the tags are entered, the system checks for possible spelling errors, misclassification, possible date errors, incomplete names (first and last are preferred), and apparent failure to separate tags with commas (which would otherwise indicate multi-word tags). To check for possible spelling and other errors, the system can look at the tags of others who are contacts of the user. For example, the system could compare a name entered by the user to names listed by friends and family of the user; if there is a similar name but spelled differently, the system can notify the use of a possible error. The system can also check tags for consistency, such as using “England” or “UK,” or using “Burma” or “Myanmar” consistently.

### Linking Tags Hierarchically

Keywords can be linked in hierarchies to improve organization. After annotating media with the tags “Cambridge,” “Massachusetts,” and “USA,” for example, a user can link these on the user's locations page, as depicted in FIGS. 2 and 3.

Hierarchies, like keywords, can be shared among users. Consequently, a user uploading a photo of Cambridge, Massachusetts or an event in Cambridge, Massachusetts for the first time, can select “Cambridge” suggested in the tag assignment screen to inherit both the keyword “Cambridge” and the keyword “Massachusetts” that another user has already linked hierarchically. As with the shared keywords, the system begins by searching the libraries of those most closely acquainted with the user first to ensure relevance. For a different user with close acquaintances in Cambridge, England, the system would initially associate Cambridge, England with the user, although the user could correct that association if in fact Cambridge, Massachusetts were desired.

### Content Consumption

The system is designed to try to provide a good searching, browsing, and sharing experience. Based on designed algorithms, users can efficiently explore multiple users' collections by clicking through tags of interest. Once tags have been hierarchically associated, it is easier to search relevant photo collections, and to find and share specific photos. Referring to FIG. 3, for example, a user who selects “Asia,” will see all pictures from India, Malaysia, and Singapore, but if the user is only interested in photos of the Taj Mahal, the user need only click on “Taj Mahal.”

Referring to FIG. 4, if the user has linked keywords, files containing those keywords are distributed in a thumbnail view based on the hierarchical organization, thereby offering a wide variety of content to explore. In this example, after the user has clicked on the keyword “earth,” the user is presented a selection of photos from different locations on earth, beginning with the highest level in the branch of the hierarchy displayed in FIG. 3 (e.g., for earth: Asia, Africa, Europe, etc.) and the first level in each sublevel of the hierarchy (e.g., for Asia: India, and for Africa: Tanzania, etc.). (In FIG. 4, the specific content of the photos is not displayed for convenience, but the photos would have content as indicated by the tags, such as of Kilimanjaro or people at an event.)

Referring to FIG. 5, when a user clicks through a tag in one person's collection, the site displays other users who have pictures containing the selected keyword. In this example, the system identifies a number of different users who have photos of the same event, a function called “Holidazzle.” The users are divided into friends and other users. Users with common interests can be introduced and encouraged to enter and explore photos relevant to them in other peoples' collections. Users can be allowed to email other users through the system. (As with FIG. 4 and FIG. 6, specific photo content is not shown for convenience).

An additional benefit of this architecture is that a user need not look through an entire collection of files (e.g., all “Holidazzle” photos) if the user is only interested in a subset of files in that collection. If the user wants to see only photos of himself or herself at the Holidazzle event, the user need only click on his or her name in the Holidazzle collection. Moreover, the user can further direct the search by clicking on other keywords associated with the photos shown (e.g., “Boston,” “Dec. 10, 2005,” or another person's name).

User registration—Invitations

The system can manage email communications and can provides an invitation feature by email. Potential and existing users can be invited to view media through an e-mail invitation that is tailored to their interests. It is assumed that people are generally most interested in themselves. Consequently, with respect to the application of this system to photos, a collection of photos is screened for a most recent photo containing the invitee and the fewest number of additional tags. That photo is included in the e-mail invitation along with a link to the collection where the photo came from.

If the invitee does not appear in the inviting user's photo collection, but is already a registered user, the system engine selects a photo containing the most relevant content based on the invitee's browsing history, the frequency with which he or she appears in photos with other people or things, or the types of photos contained in his or her own collection. For example if the invitee has clicked on a lot of car pictures, or has numerous car photos in her collection, the engine might select a picture of a prominently featured car.

FIG. 6 depicts an example in which an existing user, Andrew, invites a potential user, Thomas, to view photos of Thomas in Andrew's collection. The inviting e-mail contains a photo of Thomas alone. The invitation feature can list other users who have photos of Thomas, so that once on the site, Thomas can browse other users' collections to see more photos of himself. A user can send emails to multiple recipients—e.g., to multiple people who attended an event. The system can check the user's tags for photos at an event and suggest that the user send invitations to names in the tags where those names are not of people who are then-current users.

As indicated above, the technology identifies a potential user's interests based on tag frequency and associations. For example, two people who frequently appear in photos together are likely interested in one another. Given this information, the technology identifies other photos that are relevant to the invitee. In FIG. 6, for example, the invitation notes in bold other people appearing in Andrew's photo collection who frequently appear in photos with Thomas.

Because this invitation content is far more relevant to the recipient than a link to a long stream of partially uninteresting pictures, the signup rate has been found to be high (>90%). People appear to be motivated to explore pictures of themselves or of things that are directly relevant to their lives, and further to register for the site by the possibility of easily exploring photos of interest in other users' (i.e., beyond the inviting user's) collections.

### Privacy Features

The system provides a set of group privacy assignments. Like prior known systems, the systems described here can have different privacy settings for family and friends, and a separate private category, the system further allows many more custom groups (e.g., 63 groups), such as “college friends” and “neighbors.” The family and friends can be standard groups provided by the system.

Referring to FIG. 7, the screen shows the ability to add and remove tags. In the box on the right, it says “make visible to” with a list of groups. The “Social Groups” page shows the groups and how they are organized. An individual can be in more than one group—this would be expected with “friends” and “close friends” where the latter would typically be a subset. This page also shows the user other users who have him or her as a friend; this feature can encourage people to add friends that they might have overlooked.

### Other Features

The system can link tags to other applications that could be useful. For example, the tags could be linked to a mapping application to view or find places, or to a white pages directory application to find contact information about people.

The system can provide further services, including quality printing of uploaded photos, as has been provided in other earlier systems.

The system can include a translator so that a user in a non-English speaking country can see an American user's English language tags displayed in the local language of the non-English speaking user.

A social score can be created for users. The social score can be determined from an algorithm that takes different factors into account. For example, the social score can include number of friends, number of events, number of photos, use of tags, and other possible factors. The score can include the use of different features of the system, thereby encouraging users to make use of or at least try various features, upload more pictures, use more tags, and encourage more friends to join.

Without limiting the foregoing, the systems and methods thus include a number of aspects and features including systems, methods, software, and computer readable media for providing shared keywords, keyword consistency, multiple groups, and an invitation feature.

These systems and method include server side methods and systems, user-side methods and systems, and combinations of user and server side methods and systems.

What is claimed:

1. A computer system implemented method for maintaining information and interacting with users through a network, the method comprising:
maintaining in memory:
user information about a plurality of users,
items of digital media content, each item of digital content associated with at least one user,
tags that serve as metadata relating to the digital media content, and
information relating to contacts between and among users;
responsive to receiving from a user a new tag relating to an item of digital media content, identifying one or more tags in memory associated with another user and relating to the same or similar item of digital media content, and
providing to the user information relating to such one or more tags used by another user,
the system thereby identifying tags entered by different users for the same or similar content to enhance consistency by having the same tags associated with the same or similar digital media content.

2. The method of claim 1, wherein the digital media content includes photographs.

3. The method of claim 1, wherein the new tag is a name that could relate to a different specific thing, and wherein the identifying includes identifying a selected one of several identical names based on relationships of the user.

4. The method of claim 1, wherein the identifying includes checking for errors by looking at metadata associated with contacts of the user.

5. The method of claim 1, further comprising, responsive to a user selecting a tag, providing all items of digital media content with that tag.

6. The method of claim 1, wherein, for at least some photographs, the tags include names of people, a location, and a date.

7. The method of claim 1, including, when a tag is entered, searching the tags of other users with a stored relationship with the user.

8. The method of claim 1, wherein the stored relationship includes friends or friends of friends.

9. A method for maintaining information and interacting with users through a network, the method comprising:
maintaining in memory:
user information about a plurality of users,
items of digital media content, each item of digital content is associated with at least one user,
tags that serve as metadata relating to the digital media content, and
information relating to contacts between and among users;
responsive to receiving a new tag from a user for an item of digital media content that relates to name that could apply to any of multiple people or places, identifying one or more tags associated with other users having a degree of contact with the user,
the system using the relationships among users to identify a specific person or place from among possibilities.

10. A method for maintaining information in a social networking site comprising:
maintaining in memory:
user information about a plurality of users,
items of digital media content, each item of digital content is associated with at least one user,
tags that serve as metadata relating to the digital media content, and
information relating to contacts between and among users;
responsive to receiving a request to invite a new prospective user, identifying digital media content including the respective user, and
sending an email to the prospective user with selected identified digital media content along with an invitation to provide information to be stored in the memory.

11. The method of claim 10, wherein the digital media are photographs, the system providing to a prospective user one or more photographs in which the prospective user appears.
